(19) United States
(12) Patent Application Publication
(10) Pub. No.: US 2016/0188753 A1
(43) Pub. Date: Jun. 30, 2016

(54) Power Grid Development Stage Division Method Based on Logistic Model

(71) Applicants: State Grid Corporation of China, Beijing (CN); Economy Research Institute of State Grid Zhejiang Electric Power Company, Hangzhou (CN)

(72) Inventors: LEIXIANG HU, Hangzhou (CN); QIAN XU, Hangzhou (CN); RONGXIANG ZHAO, Hangzhou (CN); DEQIANG GAN, Hangzhou (CN); ZHOU LAN, Hangzhou (CN); QUANMING ZHANG, Hangzhou (CN); HAO WU, Hangzhou (CN); BO ZHOU, Hangzhou (CN)

(73) Assignees: State Grid Corporation of China, Beijing (CN); Economy Research Institute of State Grid Zhejiang Electric Power Company

(21) Appl. No.: 14/979,394

(22) Filed: Dec. 27, 2015

(30) Foreign Application Priority Data
Dec. 25, 2014 (CN) 201410826659.2

(51) Int. Cl. G06F 17/50; G06F 17/10

(52) U.S. Cl. CPC G06F 17/50; G06F 17/10

(57) ABSTRACT

A power grid development stage division method based on Logistic model. The method uses per capita household power consumption as the primary characteristic value in power grid development according to correlation analysis results and deduces a power grid development stage division theory that power grid development generally goes through a primary stage, a fast-growing stage, a posterior stage and an equilibrated stage on the basis of the Logistic model. s The provided power grid development stage division method offers decision references to planning, construction, operation and maintenance of power grid and is of great significance in timely switching work priorities, sticking to work trend and ensuring sustainable development during power grid development.

### CROSS REFERENCE TO RELATED PATENT APPLICATION The present application claims the priority of CN2014108266592 filed on Dec. 25, 2014, which application is incorporated herein by reference.

### FIELD OF THE INVENTION

The invention belongs to the technical field of power grid development stage analysis and in particular relates to a power grid development stage division method based on Logistic model.

### BACKGROUND OF THE INVENTION

China's total power generation capacity has overtaken the United States to the first and surpassed the world average level. The massive structure is solid, developed and stable, domestic and overseas researches on power grid development had carried out since the mid-1990s. However, problems in China like unsubstantial power architectures in some areas and imbalance in regional power grid development still exist, and existing research achievements fail to elaborate power development traits in different stages and to touch upon power grid development characteristics and so on.

### SUMMARY OF THE INVENTION

In order to analyze development process of the power grid and scientifically divide development stage of the power grid and get characteristics of various development stages, the invention provides a power grid development stage division method based on Logistic model, and the power grid development stage theory proposed in the method is of great guidance significance in practical development of the power grid.

The invention aims to solve the technical problem and provides the power grid development stage division method analyzing power grid development trend based on the Logistic model by regression,

The formula of the Logistic model is:

$$y = \frac{c}{1 + {e}^{a - bt}} ,$$

where the function of variable y with regard to time t is called as Logistic function; c is a function saturation value; a is a parameter correlated to an initial value; b is a growth parameter, and e is a growth parameter and e is a natural constant.

Determine three characteristic points and time nodes of the power grid development stages, and indicate time values T₁, T₂ and T₃ corresponding to the characteristic points by:

$$\{ \begin{matrix}{T}_{1} = \frac{a - 1.317}{b} + {t}_{0} \\ {T}_{2} = \frac{a}{b} + {t}_{0} \\ {T}_{3} = \frac{a + 1.317}{b} + {t}_{0}\end{matrix} ,$$

where a is a parameter correlated to the initial value, b is the growth parameter, and t₀ is a cardinal time node number.

According to the primary stage, the fast-growing stage, the posterior stage and the equilibrated stage of the power grid development stage divided based on the Logistic model, the primary stage starts and ends from −∞ to T₁, the fast-growing stage from T₁ to T₂, the posterior stage from T₂ to T₃, and the equilibrated stage from T₃ to +∞.

Per capita household power consumption is used as the main fitted characteristic value for regression analysis of the power grid and per capita transformer capacity as the alternative main characteristic value. It can be obtained that stage division using per capita household power consumption and per capita transformer capacity as the main fitted characteristic values comes closer to the reality through comparative analysis of the determination coefficient, and that using the length of 220 kV overhead lines as the fitted characteristic value enters the fast-growing stage, the posterior stage and the equilibrated stage prematurely, which does not live up to the reality.

The Logistic model can describe the ‘S’-type development process of an object under resource constraints and has been widely applied to research fields such as demography, city and town development and commercial organization.

The reason why in the method the Logistic model is used for regression analysis of the power grid is that the self-development rule of the power grid development is somewhat similar to ‘S’-type Logistic curve. In the early stage of the power grid development, construction seems sluggish as economic development has just started and power demand continues to stay low. However, as economy scale grows fast, power demand increases as well, and power grid development steps into the fast growing stage and gains its highest growth rate at some time. Later, economic development tends to be stable but still at high growth rate, at last, regional power supply reaches balance and power demand is kept stable. It is found that the Logistic fitting method is slightly superior to the quadratic curve fitting method and much to the exponential fitting method by comparing different models.

Therefore, based on above, the invention provides a power grid development stage division method dividing the power grid development into four stages including the primary development stage, the fast-growing stage, the posterior stage and the equilibrated stage on the basis of regression analysis of the Logistic model, and the power grid development stage division method is of great significance in timely switching work priorities, sticking to work trend and ensuring sustainable development during power grid development of China. Further, per capita power investment is used as elasticity coefficient to analyze relation between power and economic development. The elasticity coefficient of per capita power investment is defined as the ratio of average growth rate of per capita power investment to annual average growth rate of national economy, and its equation is:

$$e = \frac{{y}_{t + 1} - {y}_{t}}{{g}_{t + 1} - {g}_{t}} \cdot \frac{{g}_{t}}{{y}_{t}} = \frac{Δ {y}_{t} / {y}_{t}}{Δ {g}_{t} / {g}_{t}} ,$$

where eₜ denotes power elasticity coefficient, yₜ denotes power consumption measure (such as power consumption, transformer capacity or length of power transmission lines) of the t^{th} year, gₜ denotes national economic index (such as GDP) of the t^{th} year, and Δyₜ and Δgₜ denote power consumption measure and absolute variation of the national economic index of the t^{th} year respectively.

The invention has the advantages that the provided power grid development stage division method offers decision making references to planning, construction, operation and maintenance of power grid and is of great significance in power grid development. The example results indicated that analysis on the power grid development trend such as per capita household power consumption, per capita transformer capacity and per capita power investment conforms to the actual development law and provides reference to planning of the power grid development. By definite division of the power grid development stage, sluggish or overspeed construction of the power system due to poor planning can be effectively reduced as well as loss caused by unchecked construction of the power system.

### BRIEF DESCRIPTION OF DRAWINGS

FIG. 1 illustrates a Logistic function curve.

FIG. 2 illustrates regression analysis of per capita household power consumption of Japan and a Chinese province.

FIG. 3 illustrates regression analysis of per capita transformer capacity of Japan and the Chinese province.

FIG. 4 illustrates analysis of elasticity coefficient of per capita power investment of Japan and the Chinese province.

### DESCRIPTION OF THE PREFERRED EMBODIMENTS

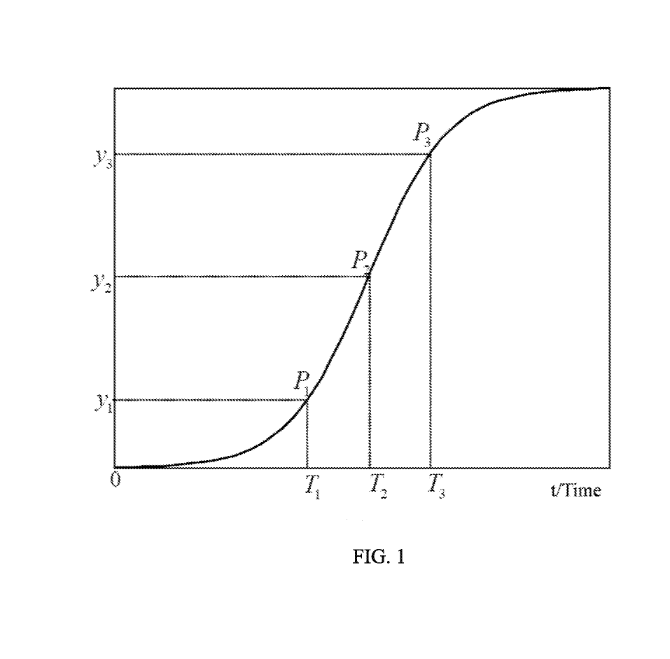

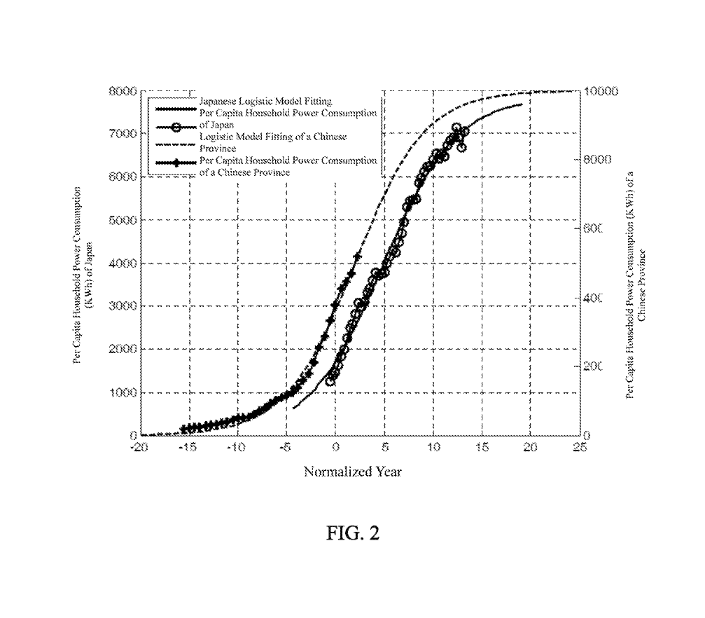

The invention provides the power grid development stage theory that power grid development generally goes through the primary stage, the fast-growing stage, the posterior stage and the equilibrated stage on the basis of relevant analysis and the Logistic model. As shown in FIG. 1, the Logistic model is a monotone increasing function and undergoes slow growth, rapid growth and equilibrated growth as t increases. As shown in FIG. 2, per capita power consumption of Japan and the certain Chinese province is subjected to regression analysis by means of relevant analysis and the logistic model, and calculation steps are shown as follows:

(1) Growth speed function of U (t) can be obtained by solving first-order derivative of Logistic function U (t), that is,

$$v ( t ) = \frac{d U}{d t} = \frac{cb {e}^{a - bt}}{{( 1 + {e}^{a - bt} )}^{2 }}$$

(2) A key point of the Logistic function can be obtained by deriving speed function v (t):

$$\frac{d v}{d t} = \frac{{d}^{2} U}{d {t}^{2}} = \frac{{cb}^{2} {e}^{a - bt} ( {e}^{a - bt} - 1 )}{{( 1 + {e}^{a - bt} )}^{3 }}$$

thus:

$${t}_{1} = {T}_{2} = \frac{a}{b}$$

where t₁ time is the point where acceleration is zero, that is, the function gains its highest growth speed at the time t₁.

(3) Continue to solve third-order derivative of U (t), thus:

$$\frac{{d}^{2} v}{d {t}^{2}} = \frac{{d}^{3} U}{d {t}^{3}} = \frac{{cb}^{3} {e}^{a - bt} ( {e}^{2 a - 2 bt} - 4 {e}^{a - bt} + 1 )}{{( 1 + {e}^{a - bt} )}^{4}}$$

and then

$${t}_{2} = {T}_{1} = \frac{a - ln ( 2 + \sqrt{3} )}{b} \approx \frac{a - 1.317}{b} , \\ {t}_{3} = {T}_{3} = \frac{a - ln ( 2 - \sqrt{3} )}{b} \approx \frac{a + 1.317}{b}$$

Various characteristic time points of the Chinese province can be obtained and converted into actual years, that is, T₁=2002, T₂=2011 and T₃=2020. Based on this, the development stage of the power grid of this province can be divided into the primary development stage before 2002, the fast-growing stage between 2002 and 2011, the posterior stage between 2011 and 2020 and the equilibrated stage after 2020.

TABLE 1

| Characteristic | | Fast-growing | | Equilibrated |
|---|---|---|---|---|
| value/stage | Primary stage | stage | Posterior stage | stage |
| T | 1978-2004 | 2004-2015 | 2015-2026 | 2026- |
| U/c | 0-21% | 21-50% | 50-79% | 79-100% |
| v | 0-256 | 256-383 | 383-256 | 256-0 |
| Power | 0.145 to 12.75 | 12.75 to 24.0 | | |
| investment | billion yuan | billion yuan | | |
| (total and | 13.03% | 18.95% | | |
| annual average | | | | |
| growth rate) | | | | |
| Transformer | 3.82 million to | 124.92 to | | |
| capacity(total | 124.92 million | 254.60 million | | |
| and annual | yuan | kVA, | | |
| average growth | kVA, | 15.71% | | |
| rate) above | 13.79% | | | |
| 20 kV | | | | |
| Numbers (total | 617 to 3,326 | 3,326 to 5,752 | | |
| and annual | 6.69% | 9.56% | | |
| average growth rate) of | | | | |
| transformers | | | | |
| above 20 kV | | | | |
| Length (total | 6,646 to | 34,997 to | | |
| and annual | 34,997 km | 51,700 km | | |
| average growth rate) of | 6.6% | 6.72% | | |
| overhead lines | | | | |
| above 20 kV | | | | |

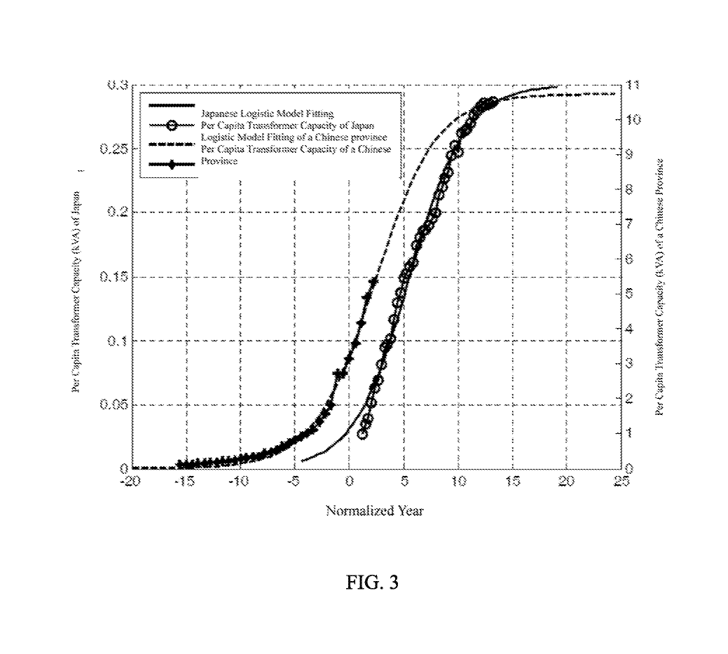

As shown in FIG. 3, it can be seen that two curves are partially overlapped in intervals 0-5 of the fast-growing stage of the power grid by regression analysis of per capita transformer capacity of Japan and the Chinese province by means of the same calculation steps as above, relevant analysis and the Logistic model, manifesting that the present development state of the power grid of this province is well matched with the fast-growing stage of Japanese power grid.

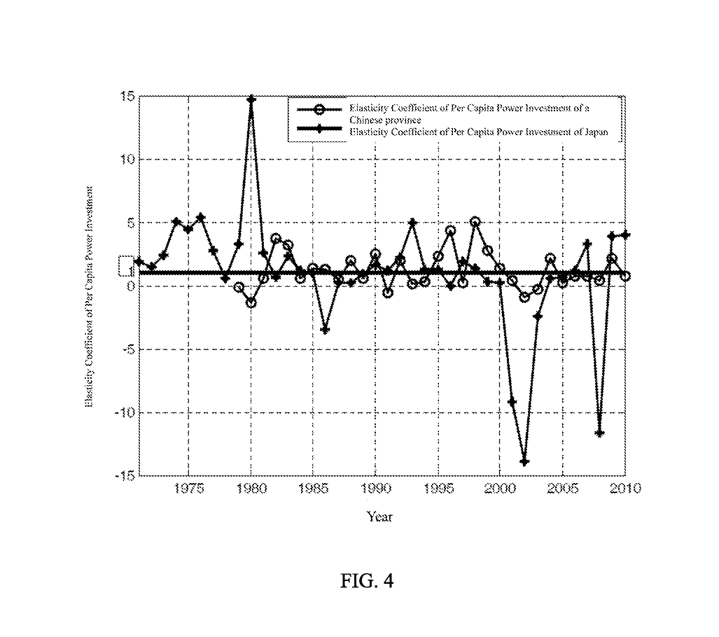

As shown in FIG. 4, the elasticity coefficients of the Japanese power grid in different development stages are illustrated and calculated according to the following equation:

$$e = \frac{{y}_{t + 1} - {y}_{t}}{{g}_{t + 1} - {g}_{t}} \cdot \frac{{g}_{t}}{{y}_{t}} = \frac{Δ {y}_{t} / {y}_{t}}{Δ {g}_{t} / {g}_{t}}$$

The calculation results showed that the elasticity coefficients of the Japanese power grid in different development stages are larger than one, approximate to one and smaller than one respectively, that is, power investment is ahead of, matched with and lag behind three stages of GDP development. While in the fast-growing stage of 2002 to 2011 in this province, the coefficient is basically smaller than one and shows that investment in power grid is not reasonably increased according to fast growth of economy, which is detrimental to power grid construction and results in that power grid construction speed cannot keep up with economic development speed and economic development speed is therefore trapped after 2011. Table 2 illustrates analysis of power grid development of Japan and Britain based on the Logistic model.

TABLE 2

| | | | | Annual power | |
|---|---|---|---|---|---|
| | | | | consumption/ | |
| | | Per capita power | | hundred | |
| | | consumption/kWh | | million kWh | |
| Indicators | | Japan | Britain | Japan | Britain |
| Characteristic | Year | 1963 | 1943 | 1966 | 1945 |
| point T₁ | Annual | 6.79 | 4.77 | 7.26 | 4.00 |
| | growth | | | | |
| | rate/% | | | | |
| Characteristic | Year | 1978 | 1964 | 1981 | 1971 |
| point T₂ | Annual | 4.31 | 3.02 | 4.61 | 2.54 |
| | growth | | | | |
| | rate/% | | | | |
| Characteristic | Year | 1994 | 1986 | 1995 | 1996 |
| point T₃ | Annual | 1.82 | 1.28 | 1.95 | 1.07 |
| | growth | | | | |
| | rate/% | | | | |
| Equilibrated values | | 8,995.1 | 6,627.9 | 11,579.6 | 4,320.7 |
| Recent level | Year 2008 | 8,071.0 | 6,061.1 | 10,307.0 | 3,721.9 |
| | Percentage/% | 89.73 | 91.45 | 89.01 | 86.14 |

The example results indicated that analysis on the power grid development trend such as per capita household power consumption, per capita transformer capacity and per capita power investment conforms to the actual development law and provides decision making reference to planning, construction, operating and maintenance and so on of the power grid. The practical value of decision making reference is embodied in planning power grid construction speed to be matched with economic development speed effectively with reference to the power grid development trend theory. Under the condition of no theory, the power grid construction scale is blind and easy to cause under investment in power grid construction from 2002 to 2011 and impede local economic development. The power grid development stage division method provides reference to power grid development planning, and by definite division of the power grid development stage, sluggish or overspeed construction of the power system due to poor planning can be effectively reduced as well as loss caused by unchecked construction of the power system.

By analyzing power grid of Japan and the province of China, specific planning proposals can be provided for power grid development of China to improve economic efficiency of power grid construction, such as:

(1) With growth of national economy, Chinese power grid can still grow at high speed in some future time. Since the Chinese power grid and economic development are unbalanced, attention should be paid to regional difference and different development stages in development so as to work out corresponding plans.

(2) Plans of the power grid should be reasonably adjusted in the posterior stage and the equilibrated stage of the power grid, work focus should be shifted to reconstruct and expand existing distribution and transmission equipment from positioning and wiring, and complications and undulation in power grid construction are avoided.

(3) Power investment plan should fit in stages of economic development and power grid development, that is, in the fast-growing stage, growth rate of power grid investment is higher than GDP growth rate, and the power grid is advanced; in the posterior stage, power investment and GDP grow mostly at the same rate, so that power grid development speed is matched with economic growth speed.

What is claimed is:

1. A power grid development stage division method based on Logistic model, wherein the power grid development stage division method analyzes power grid development trend based on the Logistic model by regression,
The formula of the Logistic model is:
$$y = \frac{c}{1 + {e}^{a - bt}} ,$$
where the function of variable y with regard to time t is called as Logistic function; c is a function saturation value; a is a parameter correlated to an initial value; b is a growth parameter, and e is a growth parameter and e is a natural constant.
Determine three characteristic points and time nodes of the power grid development stages, and indicate time values T₁, T₂ and T₃ corresponding to the characteristic points by:
$$\{ \begin{matrix}{T}_{1} = \frac{a - 1.317}{b} + {t}_{0} \\ {T}_{2} = \frac{a}{b} + {t}_{0} \\ {T}_{3} = \frac{a + 1.317}{b} + {t}_{0}\end{matrix} ,$$
where a is a parameter correlated to the initial value; b is the growth parameter, and t₀ is a cardinal time node number.
According to the primary stage, the fast-growing stage, the posterior stage and the equilibrated stage of the power grid development stage divided based on the Logistic model, the primary stage starts and ends from −∞ to T₁, the fast-growing stage from T₁ to T₂, the posterior stage from T₂ to T₃, and the equilibrated stage from T₃ to +∞.
Use per capita household power consumption as a main fitted characteristic vector of regression analysis of the power grid and per capita transformer capacity as an alternative main characteristic vector.
$$e = \frac{{y}_{t + 1} - {y}_{t}}{{g}_{t + 1} - {g}_{t}} \cdot \frac{{g}_{t}}{{y}_{t}} = \frac{Δ {y}_{t} / {y}_{t}}{Δ {g}_{t} / {g}_{t}} .$$

2. A power grid development stage division method based on Logistic model according to claim 1, wherein per capita power investment is used as elasticity coefficient to analyze relation between power and economic development. The elasticity coefficient of per capita power investment is defined as the ratio of average growth rate of per capita power investment to annual average growth rate of national economy, and its equation is:
$$e = \frac{{y}_{t + 1} - {y}_{t}}{{g}_{t + 1} - {g}_{t}} \cdot \frac{{g}_{t}}{{y}_{t}} = \frac{Δ {y}_{t} / {y}_{t}}{Δ {g}_{t} / {g}_{t}} ,$$
where eₜ denotes power elasticity coefficient, yₜ denotes power consumption measure of the t^{th} year, gₜ denotes national economic index of the t^{th} year, and Δyₜ and Δgₜ denote power consumption measure and absolute variation of the national economic index of the t^{th} year respectively.
